(19) United States
(12) Patent Application Publication
(10) Pub. No.: US 2026/0138892 A1
(43) Pub. Date: May 21, 2026

(54) CONTAMINANT FILTRATION APPARATUS FOR BODY OF WATER

(71) Applicant: Lakewater Nutrient Capture Ltd., Winnipeg (CA)

(72) Inventor: Joel Stewart Weber, Winnipeg (CA)

(21) Appl. No.: 19/327,270

(22) Filed: Sep. 12, 2025

Related U.S. Application Data
(60) Provisional application No. 63/699,311, filed on Sep. 26, 2024.

(51) Int. Cl. C02F 1/00; C02F 1/28

(52) U.S. Cl. CPC C02F 1/004; C02F 1/281; C02F 2201/005; C02F 2201/006; C02F 2201/46145

(57) ABSTRACT

A filtration apparatus for removing a contaminant from a body of water includes a marine vessel arranged and filtration cartridges on the vessel having filtration media for absorbing the contaminant. The vessel is operable between a first configuration in which the cartridge is supported on the vessel for floating transport and a second configuration in which the cartridge is submerged such that the filtration media openly communicates with the body of water. The cartridges may be palletized for ease of deployment and replacement. In one embodiment, the vessel may be fully submerged with the filtration media in the first configuration. In another embodiment, a lift displaces the filtration media through a well in the vessel for submerging the media.

This application claims the benefit under 35 U.S.C. 119(e) of U.S. provisional application Ser. No. 63/699,311, filed Sep. 26, 2024.

### FIELD OF THE INVENTION

The present invention relates to a filtration apparatus for removing a contaminant or pollutant such as plastic, metal, or excess nutrients including phosphorous and the like, from a body of water such as a river, a pond or a lake, and more particularly the present invention relates to a filtration apparatus including filtration media arranged to absorb contaminants in solution in the water such as iron-hydroxide modules arranged to absorb water soluble phosphates from the water.

### BACKGROUND

Many waterbodies such as lakes and rivers are polluted with contaminates generated from agricultural & waste treatment industries which require capture and removal. US Patent Application Publication No. US 2013/0098840 by Helferich (incorporated herein by reference) describes a porous composite media for moving phosphorous from water, but no deployment system is described. Use of an active filtration system using pumps are generally considered too complex and costly to deploy on a large scale. Other attempts to support such filtration media within a netted structure placed within a body of water may not be secure from wildlife or human intrusion, or may not be deployable to a depth to facilitate full submersion. A low tech, passive solution is required to address the issue of filtering massive quantities of water of these contaminates.

### SUMMARY OF THE INVENTION

It is an object of the present invention to provide a container for the use in passive underwater filtering of water contaminate such as water-soluble nutrients, heavy metals, plastics, and pharmaceuticals.

According to one aspect of the invention there is provided a filtration apparatus for removing a contaminant from a body of water, the apparatus comprising:
a marine vessel arranged for flotation within the body of water; and
at least one filtration cartridge supported on the vessel, the filtration cartridge comprising filtration media arranged to absorb the contaminant from the body of water;
the vessel being operable between a first configuration in which said at least one filtration cartridge is supported on the vessel for floating transport across the body of water and a second configuration in which said at least one cartridge is submerged within the body of water such that the filtration media is in open communication with the body of water.

Providing suitable filtration media in cartridges which are supported on a vessel in a palletized manner so as to be arranged for deployment in a manner which allows the passive hydraulic flow of the water through the container and palletized filtration material provides an effective, low-cost solution for capture and removal of contaminants from a body of water.

The at least one filtration cartridge may comprise a plurality of modules of the filtration media supported within a cartridge frame surrounding the modules so as to allow water to flow through the cartridge frame between the modules, in which the cartridge frame includes a pallet base such that the cartridge frame is adapted to be transported by pallet handling equipment.

The cartridge may further include a lift hook mounted centrally at a top of the cartridge frame such that the cartridge frame is adapted to be suspended by the lift hook from a crane.

The filtration media may comprise nano iron-hydroxide arranged to absorb water soluble phosphates from the body of water.

According to one embodiment, the vessel may be arranged to be fully submerged to engage a floor of the body of water in the first configuration.

The vessel may include at least one variable buoyancy chamber operable to displace the vessel between a floating state in the first configuration and a submerged state in the second configuration.

Preferably the vessel includes flow openings spanning a majority of two laterally opposing sides of the vessel in the first configuration such that the vessel is arranged to receive water flowing laterally through the vessel in the first configuration.

A door may be operatively associated with each flow opening in which the door is operable between (I) an open position in the first configuration in which the flow opening is substantially unobstructed by the door and (il) a closed position in which the flow opening is closed by the door.

Each door may be hinged at a bottom side of the door such that the door is pivoted downwardly and laterally outwardly from the closed position to the open position.

The at least one variable buoyancy chamber may comprise an inflatable pontoon mounted to the vessel below the door such that displacement of the door towards the open position collapses the pontoon against a floor of the body of water. The vessel preferably includes loading doors supported at one end of the vessel through which said at least one filtration cartridge is arranged to be loaded and unloaded using pallet handling equipment.

According to the illustrated embodiment, the vessel comprises a modified intermodal container, in which a floor of the container comprises metal grating allowing flow of water therethrough and a top of the container includes a vent opening therein through which air can escape when submerging the vessel.

According to another embodiment, the vessel may comprise (i) a hull arranged for flotation on the body of water, (ii) a well communicating through the hull, and (iii) a lift operable to displace said at least one filtration cartridge through the well and relative to the hull between a working position submerged in the body of water below the hull corresponding to the second configuration and a transport position in which said at least one cartridge is raised relative to the lower position corresponding to the first configuration.

The lift may support a lift frame thereon for movement between the working position and the transport position, in which said at least one cartridge comprises a plurality of filtration cartridges supported on the lift frame for displacement together with the lift frame between the working position and the transport position.

When the vessel includes a deck having an upper supporting surface arranged to support pallet handling equipment thereon, the lift may be operable to displace the lift frame into a loading position above the deck such that the filtration cartridges can be loaded onto and unloaded from the lift frame by the pallet handling equipment on the deck.

The vessel may further include an anchor post supported on the vesse for vertical displacement between a raised position above a bottom of the hull for transport and a lowered position extending between the hull and a floor of the body of water to anchor the vessel relative to the floor of the body of water.

According to a second aspect of the present invention there is provided a method of removing a contaminant from a body of water, the method comprising:
providing at least one filtration cartridge supported on a vessel for flotation on the body of water in which the filtration cartridge comprises filtration media arranged to absorb the contaminant from the body of water;
operating the vessel to submerge said at least one cartridge within the body of water such that the filtration media is in open communication with the body of water;
when the filtration media is saturated with the contaminant, raising said at least one filtration cartridge from the body of water and transporting said at least one filtration cartridge to a loading deck;
replacing said at least one filtration cartridge on the vessel having saturated filtration media therein with at least one replacement cartridge from the loading deck; and
transporting the vessel across the body of water with said at least one replacement cartridge supported thereon.

According to a first embodiment, the method includes submerging said at least one filtration cartridge within the body of water by submerging the vessel until the vessel rests on a floor of the body of water.

According to a second embodiment, the method includes submerging said at least one filtration cartridge within the body of water by suspending said at least one filtration below the vessel.

According to one aspect, the invention pertains to a nonpoint source passive underwater filter utilizing a modified shipping container to capture containments in water bodies such as rivers & lakes. More particularly, a rectangular passive underwater filtration container for the use in lakes and rivers to capture water containments utilizing interchangeable palletized media stored within the container. The container is submerged and the sidewall doors swing outwards on either side, facilitating the free flow of water crosswise through openings in the sidewall of the container and the filtration media.

Other aspects of the invention will become apparent to those of skill in the art upon reviewing the present specification.

### BRIEF DESCRIPTION OF THE DRAWINGS

Various embodiments of the invention will now be described in conjunction with the accompanying drawings in which:

FIG. 1 is a perspective view of a first embodiment of the filtration apparatus;

FIG. 2 is a partly sectional perspective view of the first embodiment of the filtration apparatus;

FIG. 3 is a sectional end view of the first embodiment of the filtration apparatus;

FIG. 4 is a side view of the first embodiment of the filtration apparatus illustrating one pontoon in a deflated position;

FIG. 5 is a side view of the first embodiment of the filtration apparatus Illustrating one pontoon in an inflated position;

FIG. 6 is a top view of the first embodiment of the filtration apparatus;

FIG. 7 is an end view of the first embodiment of the filtration apparatus showing one pontoon in an inflated position and one pontoon in a deflated position;

FIG. 8 is a partly sectional end view according to FIG. 7;

FIG. 9 is a schematic representation of a valving arrangement for delivering pressurized gas to the pontoons in the first embodiment of the filtration apparatus;

FIG. 10 is a schematic end view of the first embodiment of the filtration apparatus displaced between the first and second configurations thereof;

FIG. 11 is a schematic side view of the first embodiment of the filtration apparatus displaced between the first and second configurations thereof;

FIG. 12 is a side view of the first embodiment of the filtration apparatus for transport on land between a processing facility and a body of water to be treated;

FIG. 13 is a side view of the first embodiment of the filtration apparatus being loaded on a transport vehicle;

FIG. 14 is a side view of the first embodiment of the filtration apparatus being towed across the body of water in the first configuration thereof;

FIG. 15 is a schematic representation illustrating an exchange of filtration cartridges between a processing facility and the body of water according to the first embodiment of the filtration apparatus;

FIG. 16 is a schematic representation of a processing facility for assessing the filtration media for reuse;

FIG. 17 is a schematic representation of the first embodiment of the filtration apparatus displaced between the first and second configurations thereof;

FIG. 18 is a schematic representation of a second embodiment of the filtration apparatus displaced between the first and second configurations thereof;

FIG. 19 is a schematic representation of a third embodiment of the filtration apparatus displaced between the first and second configurations thereof;

FIG. 20 is a schematic representation of a fourth embodiment of the filtration apparatus;

FIG. 21 is a schematic representation of the filtration apparatus according to the fourth embodiment of FIG. 20, shown displaced between various configurations thereof including a working position, a transport position, and a loading position of the cartridges relative to the vessel; and

FIG. 22 is a schematic representation of one of the filtration cartridges supported on the filtration apparatus according to any of the previous embodiments.

In the drawings like characters of reference indicate corresponding parts in the different figures.

### DETAILED DESCRIPTION

Referring to the accompanying figures there is illustrated a filtration apparatus generally indicated by reference numeral 10. The apparatus 10 is particularly suited for removing a contaminant from a body of water, for example water-soluble nutrients such as phosphates, heavy metals, plastics, and pharmaceuticals.

Although various embodiments are shown in the accompanying figures, the features in common with the various embodiments will first be described.

In each instance, the filtration apparatus 10 generally comprises a marine vessel 12 adapted for flotation and transport across a body of water. A plurality of filtration cartridges 14 are supported on the vessel in which each filtration cartridge comprises filtration media supported thereon that is arranged to absorb one or more contaminants from the body of water when submerged in open communication with the surrounding body of water. In each instance the vessel 12 is generally operable between a first configuration corresponding to a transport position in which the filtration cartridges are supported on the vessel such that the vessel is suited for transport across the body water and a second configuration corresponding to a working position of the filtration media in which the filtration media is fully submerged and in open communication with the body of water.

Each filtration cartridge 14 supports the filtration media thereon in a palletized manner by providing a cartridge frame 16 having a pallet base 18. For example, the base of the cartridge may include a rigid supporting deck 20 similar to the size of a conventional pallet, for example 4 feet by 4 feet, with a plurality of depending ribs 22 extending longitudinally across the deck at laterally spaced positions parallel to one another to define lengthwise pockets between the ribs which support the deck spaced above a supporting surface upon which the base is engaged. The pockets between the ribs 22 are suitably sized and arranged to receive the forks of pallet handling equipment therein such that the cartridge can be lifted, transported, and generally handled by the pallet handling equipment in the usual manner of a pallet.

Each filtration cartridge 14 further includes a plurality of units 24 stacked on the deck 20 in which the units comprise rectangular, cubic shaped cages of open mesh material which receive a plurality of individual modules of filtration media stacked therein. In a preferred embodiment, the filtration media comprises individual sponges of nano iron hydroxide having a brick shape with protrusions on one side of the brick that act as spacers such that stacking of the bricks results in flow gaps between adjacent modules through which flow of water can pass so that all surfaces of each module are exposed to a surrounding body of water when the units stacked on the pallet base of a cartridge frame are submerged in the body of water.

The cartridge frame further includes a top plate 26 of similar dimensions to the pallet base and which is connected to the pallet base at each of the four corners thereof by a respective corner post 28 in the form of a rigid rod fastened between the pallet base and the top plate. A lift hook 30 is mounted centrally on the top plate to protrude from the top side of the cartridge frame so as to be arranged for connection to a lift cable of a crane to further enable transport and handling of the individual filter cartridges 14. The cartridge frames are also suitably arranged to be stacked one upon the other as desired.

In each embodiment, the filter cartridges are supported on the marine vessel 12 so that the marine vessel can deploy the cartridges by first transporting the cartridges over the body water to a desired treatment location. At the treatment location, the vessel is operated to submerge the filter cartridges 14 within the body of water. The filter cartridges can remain submerged for an elapsed time corresponding to the approximate time for the filtration media to become saturated with the corresponding contaminant, for example phosphates in the instance of nano iron hydroxide filtration media. Alternatively, sensing can be used to monitor saturation levels. Once it is determined that the filtration media has been suitably saturated with contaminant, the filtration cartridges are lifted from the body water to return the vessel to a transport configuration for return of the vessel to a loading area such as a dock or shoreline. Cartridges on the vessel may be replaced with unsaturated replacement filter cartridges at the loading area, or the entire vessel may be transported to a processing facility where the cartridges are replaced with unsaturated replacement filtration cartridges. The vessel is then redeployed over the water to the treatment location or a new treatment location for subsequent submerging of the replacement filtration cartridges in the same manner as described above.

In each embodiment, saturated filtration cartridges are processed in a similar manner, for example using a facility as represented schematically in FIG. 16. In the instance of phosphates, the regeneration and extraction of phosphates from the filtration media involves use of a volume of 1 M of NaOH equal in volume to the volume of the PO4 media. The NaOH is circulated through the media for 60 minutes. Recirculation is repeated with fresh 1 M NaOH in which two cycles will remove approximately 80% of the PO4 ions, The media can then be recirculated with tapwater that is free of phosphates that is double in volume of the NaOH for 15 minutes. The media can also be recirculated with a mild acid, for example a 0.1% citric acid of the same volume as water for 15 minutes. The media can then be recirculated with tapwater for another 15 minutes or until the pH of water approximately in the range of 7 to 7.5. Samples of NaOH and PO4 solutions are taken and analysed for phosphorus concentration.

Alternatively for recovery of phosphorus as calcium phosphate, calcium chloride is added for the phosphorus to be precipitated as calcium phosphate and the solution is stirred for 10 minutes. After allowing two hours for precipitate flocks to form and settle out, the solution is filtered to remove the precipitates. A 25 micron or 5 micron filter paper or other method can be used to remove the precipitates from the liquid. The NaOH/CaCl2 solution can be reused for more regenerations, but after six uses, chlorine lowers PO4 removal and solutions need to be neutralized with acid for discharge. Calcium phosphate is dried and weighed to confirm the amount of extraction.

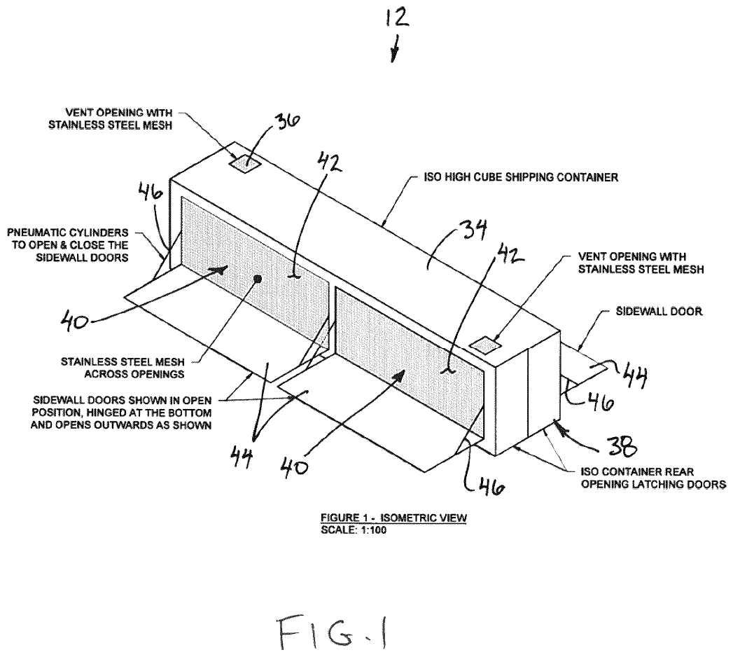

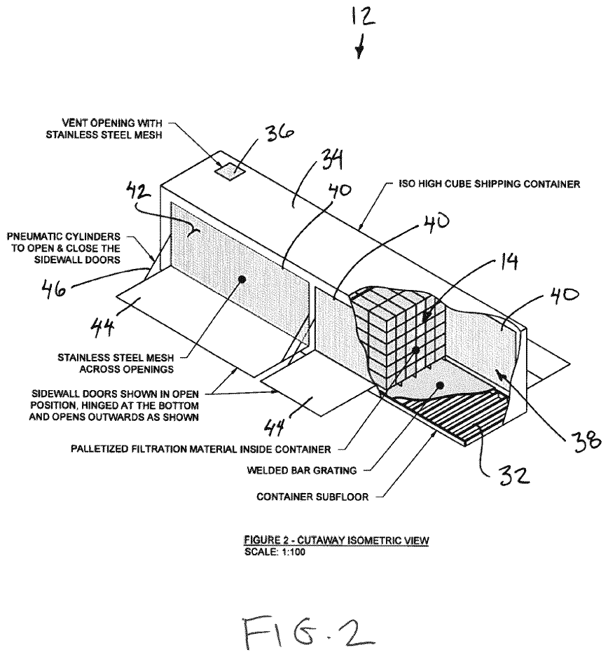

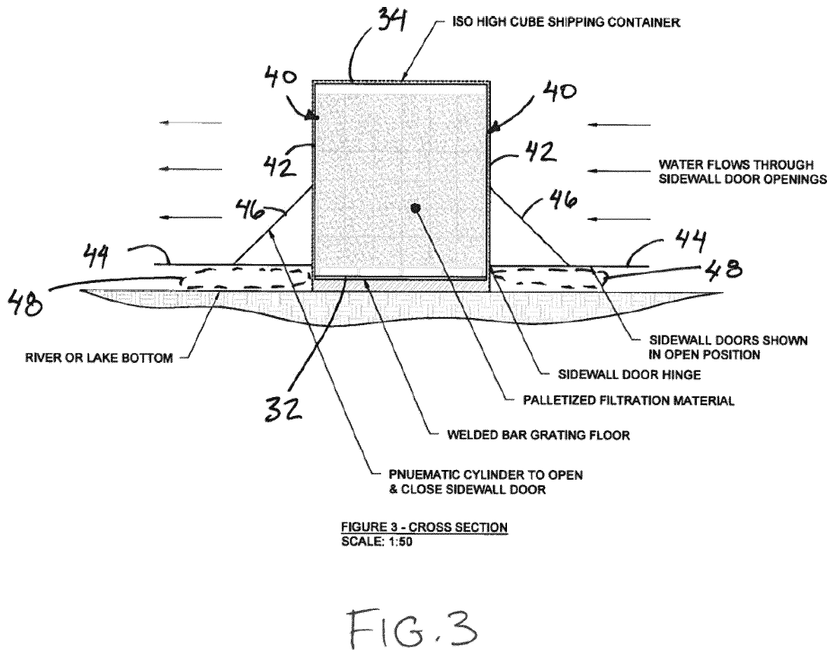

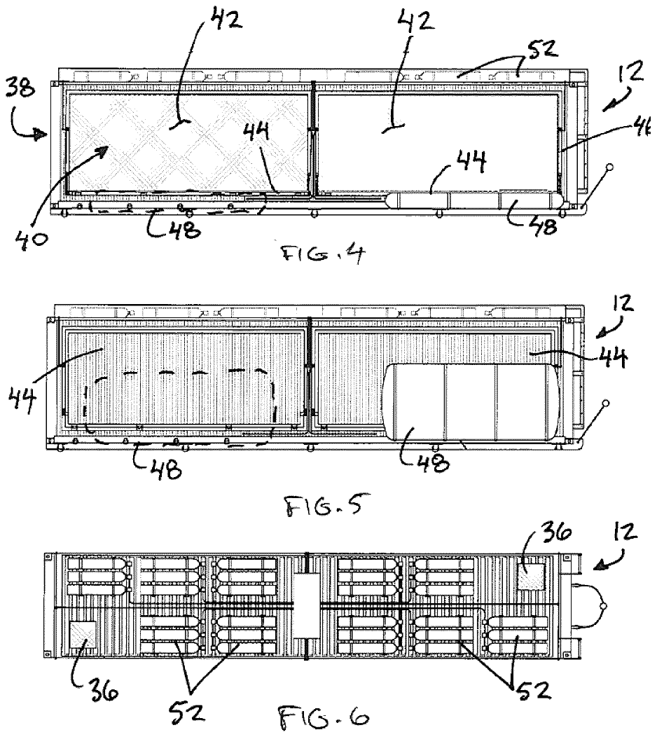

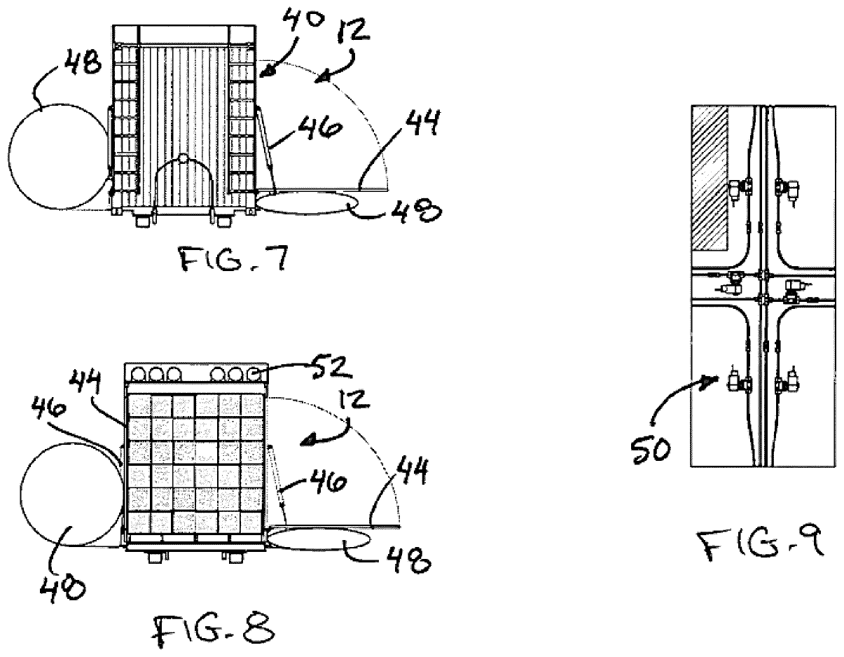

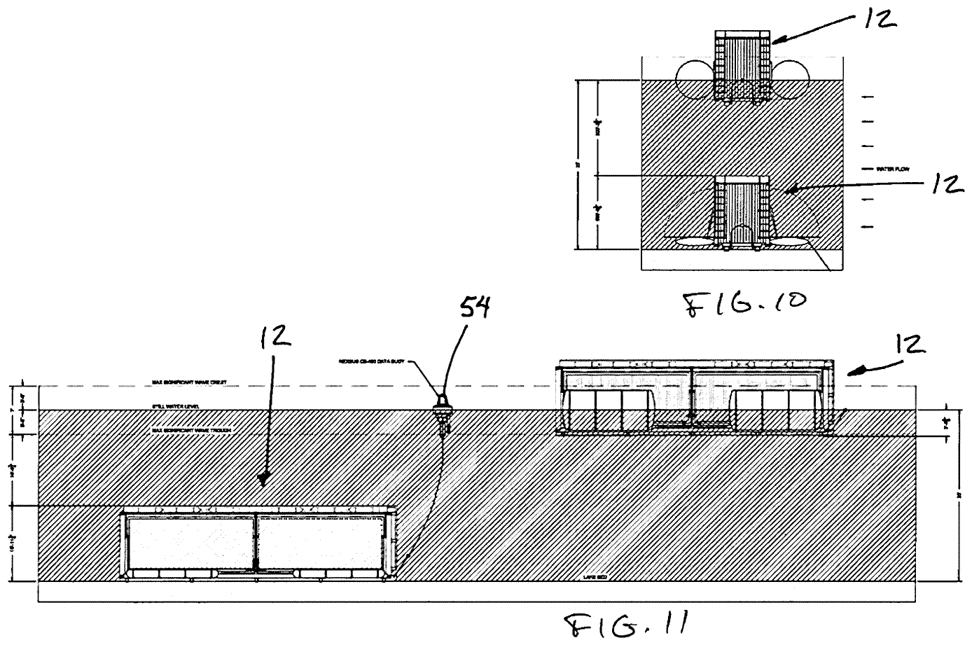

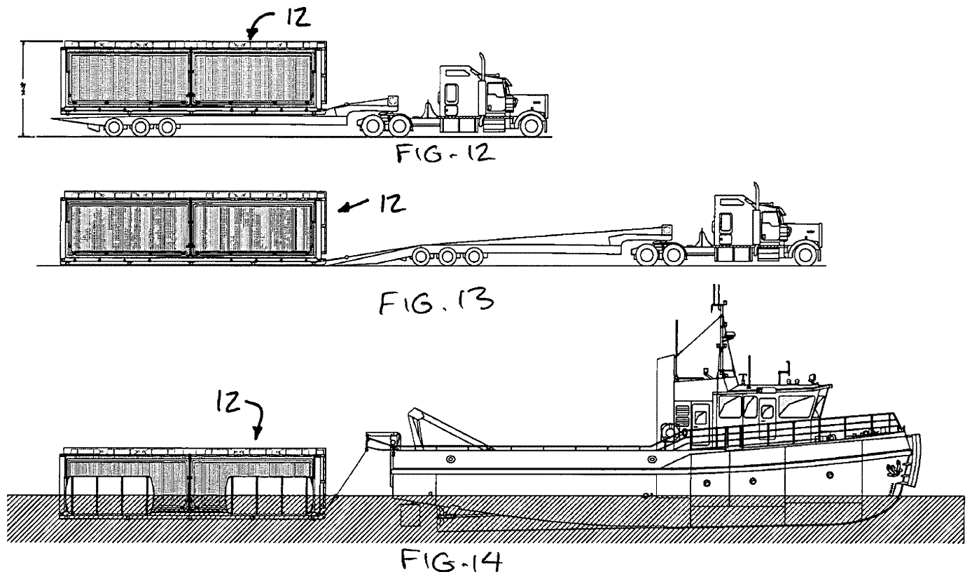

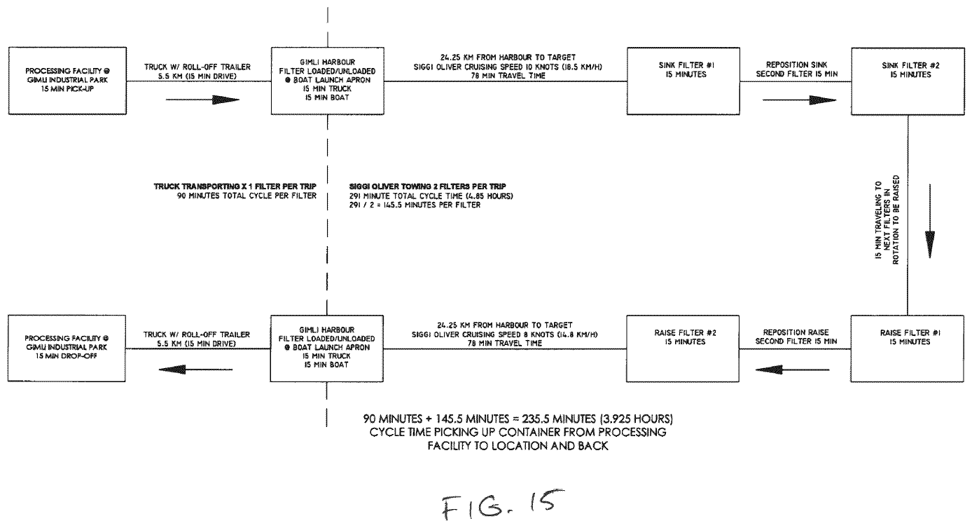

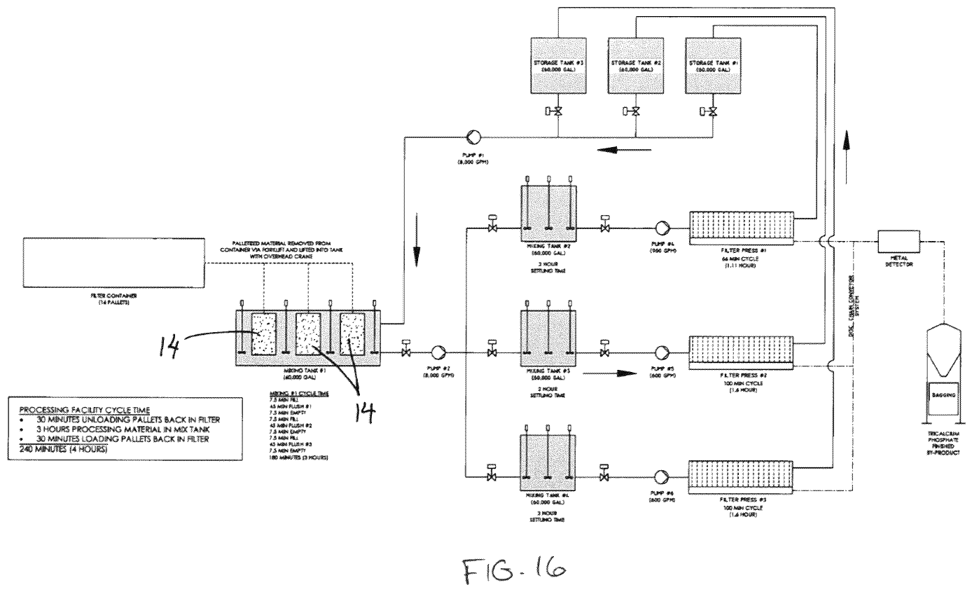

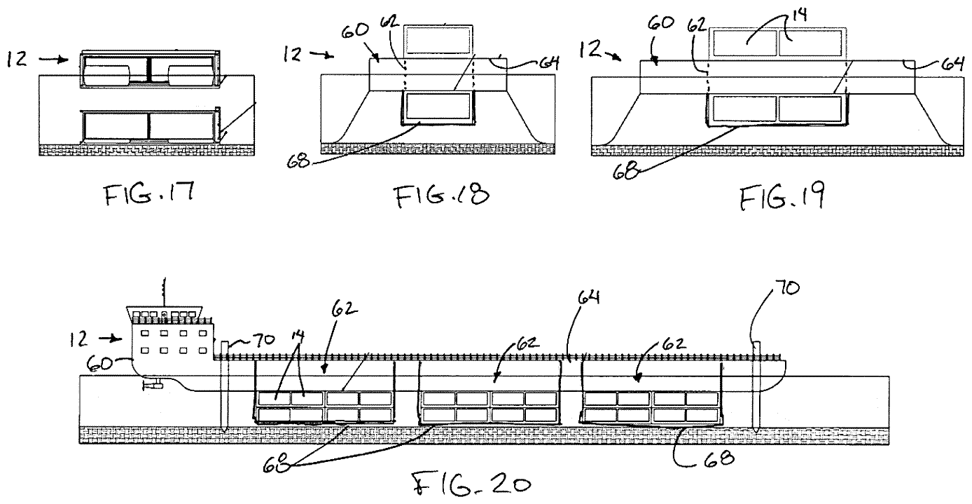

Turning now more particularly to the first embodiment shown in FIGS. 1 through 17, the marine vessel 12 in this instance comprises a modified intermodal container in which the entire vessel is arranged to be submerged until it rests on the floor of the body of water as a means of submerging the filtration cartridges into a working position corresponding to the second configuration of the filtration apparatus described above.

The hull of the vessel 12 in this instance comprises the rectangular walls and roof of the modified intermodal container. The floor of the container is removed and replaced with a rigid grate having openings therein that readily allow flow of water into and out of the container, while being structurally supporting for supporting a large number of the filtration cartridges thereon. The roof 34 generally remains closed but includes one or more vents 36 formed therein at the top of the container which are covered with a metal mesh material to allow air to be readily introduced into or exhausted from the interior of the vessel.

A loading opening 38 spans the height and width at one end of the container for receiving pallet handling equipment therethrough to load and unload the filtration cartridges relative to the interior of the container defining the vessel 12.

The vessel also includes a plurality of flow openings 40 in the form of two large openings spanning respective portions of each of two laterally opposing sides of the container. The flow openings at each side collectively span a majority of the surface area of the longitudinally extending sides of the container forming the vessel 12. When the flow openings are open and unrestricted, a flow of water can readily flow laterally through the vessel when the vessel is submerged in the body water. A suitable mesh material such as a metal stainless steel mesh fully spans each flow opening so as to protect the container from debris entering the interior of the vessel without obstructing flow of water through the vessel.

A suitable door 44 is associated with each flow opening 40 which is hinged to the container along a bottom edge of the door corresponding to a bottom edge of the respective opening. In a closed position each door 44 fully spans the respective flow opening to fully close the flow opening. The doors 44 are opened by swinging the doors downwardly and laterally outwardly such that the doors extend primarily horizontally such that the doors substantially lay on or adjacent to the floor of the body water when the vessel is sitting on the floor of the body water in the second configuration. The flow openings are thus unobstructed by the doors when the doors are open. A suitable actuator 46 is operatively connected between each door and the rigid frame of the container defining the vessel 12 so as to controllably displace the door between the open and closed positions thereof. In the open position of the doors corresponding to the second configuration of the vessel, the doors are held open by the actuators such that the doors function as stabilizers that increases the footprint of the vessel resting on the floor of the body of water while also covering debris on the floor of the body water immediately adjacent the flow openings to restrict entry of some debris into the container.

One or more variable buoyancy chambers 48 are provided on the vessel 12 according to the first embodiment for displacing the entirety of the vessel between a first configuration floating on the body of water for transport or the second configuration fully submerged in the body water and resting on the floor of the body water. In the illustrated embodiment, the variable buoyancy chamber comprises a plurality of inflatable pontoons extending longitudinally along the laterally opposing long sides of the container. The pontoons 48 are preferably anchored to the container adjacent a bottom of the container at a location below the hinges of corresponding doors 44, The pontoons are operatively connected by suitable valves 50 to both (i) a source of compressed air in the form of an array of supply tanks 52 mounted on the roof of the container, and (ii) one or more discharge valves for venting to atmosphere. Under control of the valves, the pontoons 48 can be inflated with air from the tanks 52 to provide buoyancy which supports the vessel 12 for flotation and transport on the body of water. Similarly, the pontoons 48 can be deflated by discharging the air to remove buoyancy such that the vessel sinks controllably to the floor of the body of water.

In use, the pontoons can be deflated controllably to gradually sink the vessel whereby water enters into the interior of the vessel through the grate in the floor and air is discharged from the vessel through the vents in the roof until the vessel rests on the floor of the body water. The doors 44 can then be opened such that the doors further collapse the pontoons 48 against the floor which acts to fully collapse the pontoons as well as protect the pontoons from damage in the working position of the filtration cartridges so that the pontoons do not obstruct the flow openings 40. The reverse operations allow the vessel to return to flotation on the body water by first closing the doors and then inflating the pontoons.

Once the vessel 12 is floating on the body water, a suitable towing vessel can be used to return the vessel to a loading area at the shore of the body water. In a preferred mode of transport, the container includes a suitable skid or wheeled bottom such that the container can be winched onto the flatbed of a winch truck for subsequent road transport to the processing facility.

In this embodiment, the entirety of the vessel is returned to a processing facility where pallet handling equipment can then exchange the saturated filtration cartridges with replacement unsaturated cartridges. For efficiency, the containers are transported with a truck with a rolloff trailer in which an entire vessel with replacement cartridges therein is transported to the body of water, and the marine towing vessel then tows the vessel 12 with replacement cartridges to the location of another vessel 12 that has saturated cartridges so as to be due for retrieval. After returning the saturated vessel 12 to the first configuration floating on the body of water and submerging the replacement vessel 12, the towing marine vessel then tows the saturated vessel 12 back to shore where it can be transferred to a transport truck and returned to the processing facility as described above.

The vessel 12 in this instance can be further provided with suitable marine navigation lights on the exterior of the container.

In order to mark the location of the vessel 12 when it is submerged according to the second configuration thereof, a marker buoy 54 is connected to each end of the container by a suitable tether in which the buoy has suitable flotation to remain at the surface of the body of water. The buoy may include basic electronics and identification lighting which are powered by solar panels also supported on the buoy.

Turning now to the further embodiments in FIGS. 18 through 20, in each of these instances the vessel 12 comprises a ship or barge having a hull 60 adapted for flotation and transport on the body of water. Furthermore in each instance the hull 60 is provided with at least one well 62 formed therein as a through-passage extending vertically through the hull and which is surrounded fully about the perimeter thereof by an upper deck 64 of the vessel having an upper supporting surface for supporting loads thereon.

In each instance, a lift is provided in association with each well 62 for displacing the filtration cartridges 14 vertically through the well relative to the hull 60 between the first configuration above the bottom of the hull for flotation and transport across the body water and the second configuration in which the cartridges 14 are fully submerged below the bottom of the hull. The lift generally comprises a series of vertical rails 62 mounted at opposing sides and/or opposing ends of the well upon which a lift frame 68 is vertically slidable. The lift frame includes a deck for supporting a plurality of the filtration cartridges 14 thereon. In some instances the lift frame 68 may comprise a container such as a modified intermodal container which is modified to include flow openings spanning a majority of opposing sides of the container which are protected by rigid metal mesh spanning over the flow openings to allow flow of water laterally through the container in communication with the cartridges therein similarly to the previous embodiment.

Lastly the lift includes a suitable actuator or motor (not shown) which drives movement of the lift frame relative to the hull 60 between a plurality of different positions. At a lowermost position, the lift frame is displaced into a working position spaced well below the bottom of the hull, corresponding to the second configuration of the apparatus 10 such that the full height of the cartridges 14 are supported below the bottom of the hull so as to be fully submerged within the body of water while being rigidly suspended below the vessel 12.

From the working position, the lift can be raised to a transport position in which the lift frame is above the bottom of the hull, but at least a portion of the cartridges 14 remain recessed below the upper supporting surface of the deck 64 of the vessel. In this manner, the filtration cartridges are fully suspended above the body of water such that the vessel is suited for transport across the body water.

The lift can be further raised from the transport position to a loading position in which the upper supporting surface of the lift frame that supports the containers thereon is located substantially at the same height as the upper supporting surface of the surrounding deck 64 of the well 62. In this manner, pallet handling equipment can drive across the deck onto the upper supporting surface of the lift frame 68 for loading and unloading filtration cartridges relative to the lift frame. In the instance of the lift frame comprising an enclosed container, the container may again be provided with access doors at one end through which the filtration cartridges can be loaded and unloaded.

In some instances, the vessel 12 can also be provided with anchor posts 70 supported for vertical sliding movement relative to the vessel 12 in which the anchor posts have an overall height which is greater than the expected depth of the body of water at the treatment location. In this manner the anchor posts 70 can be vertically slidable between (i) a transport position raised above the bottom of the hull so as not to interfere with transport of the vessel across the body of water and (il) a working position in which the anchor posts are slid downwardly under control of an actuator or motor to engage the floor of the body water and form a rigid connection between the floor and the hull of the vessel 12 to anchor the vessel at the treatment location.

Turning now more specifically to the embodiment of FIG. 18, in this instance the vessel may comprise a barge that can be anchored to the floor of the body of water using conventional tethered anchors at longitudinally opposing ends of the barge. The barge in this instance may be adapted from a 20-foot intermodal container, while the lift frame is suitable for supporting a set of filtration cartridges thereon in a single layer.

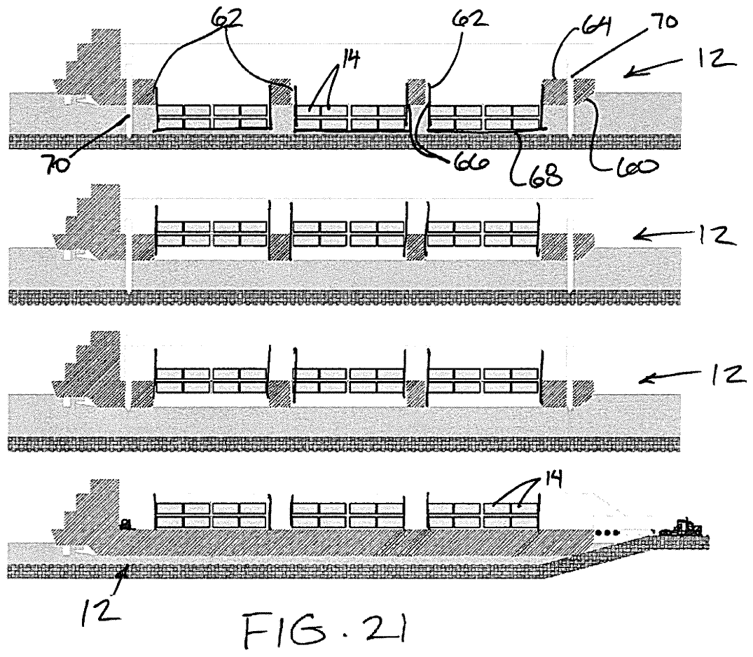

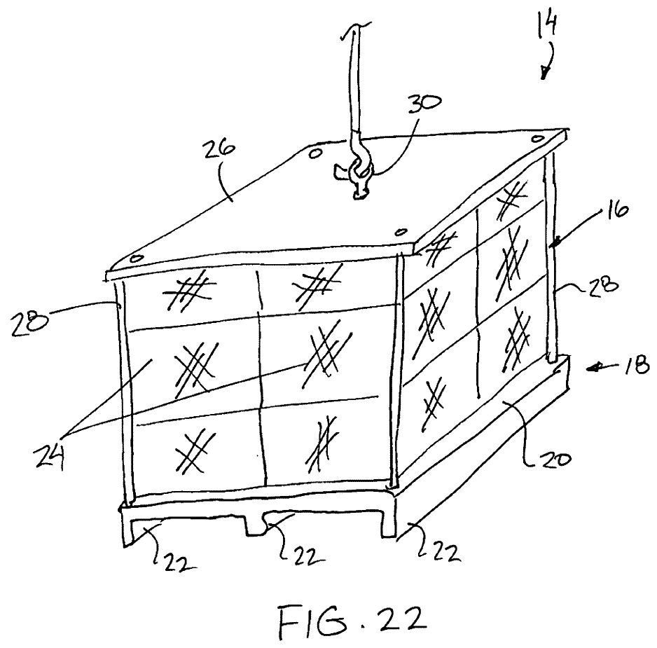

According to the embodiment of FIG. 19, in this instance the vessel may comprise a barge similarly to the previous embodiment, but instead be adapted from a 40-foot intermodal container, while the lift frame is suitable for supporting a set of 16 filtration cartridges thereon.

According to the embodiment of FIG. 20, the vessel 12 in this instance may comprise a large container ship having multiple wells 62 formed therein. Each lift frame in this instance may be much larger in size to allow stacking of the filtration cartridges and to allow a much larger footprint of cartridges to be supported adjacent one another within each stacked level of cartridges.

In each of the above instances, the cartridges may also be loaded and unloaded from the vessel 12 using a crane attached to the lift hook at the top of each cartridge.

When the vessel is a permanent floating marine vessel according to the embodiments of FIGS. 18 through 20, the process for replacing saturated filtration cartridges with unsaturated cartridges may involve displacement of the vessel 12 to a loading location such as a loading dock where unsaturated cartridges are located such that saturated cartridges are directly exchanged with unsaturated cartridges at the loading dock and the saturated cartridges at the loading dock are then loaded onto a suitable transport vehicle for transport to a processing facility.

As described above according to one embodiment, the apparatus 10 is an enclosed rectangular environmentally resistant container having a horizontal floor, a horizontal roof and four vertical walls including two sidewalls, a rear wall and a front wall. The container used needs to be a “once used” or new shipping container that meets all ISO (International Standards Organization) standards. The containers needs to be a high cube style container. Dimensions for the filter container of Length x Width x Height are 40′=12192 mm×8′=2438 mm×9′−6″=2896 mm. The inside dimensions are 39′ 3.24″=12022 mm×7 ′ 8.5″=2352 mm×8′ 10″=2692 mm. Both sidewalls have openings & doors installed that open outward and down, hinged at the bottom to facilitate water flow through the container. The doors are operable to open & close utilizing a pneumatic system expanding and contracting pneumatic cylinders pinned to the container and the sidewall doors. Separate pneumatic cylinders engage door locks to prevent the doors from opening when not deployed. An onboard controller controls the pneumatic functions. Roof vent openings to permit the infiltration & the escape of air when the container is in the process of sinking or raised. Stainless steel mesh across sidewall openings, roof vent openings secure against infiltration of wildlife & debris. The wooden floor replaced with welded steel bar grating to facilitate sinking & drivable surface. Maritime navigation lights installed on container exterior to facilitate safe transportation while being transported; green light on portside, red light on starboard side, and white at the rear of the container while transported. Sacrificial rectangular magnesium anode placed on container exterior to protect against rust and corrosion. The interior and exterior of the container painted with environmentally resistant paint to facilitate washing & disinfecting between uses. Palletized filter material arranged side by side and spaced evenly along the interior length of the container. Rear latching doors facilitate the loading and unloading of the pallets while the container is out of the water.

The apparatus 10 is arranged for filtering water and comprises an enclosed rectangular environmentally resistant container having a horizontal floor, a horizontal roof and four vertical walls including two sidewalls, a rear wall comprising of two latching doors and a front wall, and a plurality of palletized filter material arranged side by side the length of the container to facilitate water filtration.

Preferably both sidewalls have openings & doors installed that open outward and down, hinged at the bottom to facilitate water flow through the container. The doors are operable to open & close with pneumatic system and an electrical system for controlling said operation.

Preferably roof vent openings permit the infiltration & the escape of air when the container is in the process of sinking or being raised.

T Preferably stainless steel mesh is installed across sidewall openings & roof vent openings to secure against infiltration of wildlife & debris.

Preferably maritime navigation lights installed on container exterior activated while transported.

Preferably the interior and exterior of the container painted with environmentally resistant paint.

Preferably maritime cautionary buoys attached via cable to either end of the container to mark location of the container on the surface.

Preferably the wooden container floor of a container is replaced with welded steel bar grating when forming the apparatus.

Since various modifications can be made in the invention as herein above described, and many apparently widely different embodiments of same made, it is intended that all matter contained in the accompanying specification shall be interpreted as illustrative only and not in a limiting sense.

1. A filtration apparatus for removing a contaminant from a body of water, the apparatus comprising:
a marine vessel arranged for flotation within the body of water; and
at least one filtration cartridge supported on the vessel, the filtration cartridge comprising filtration media arranged to absorb the contaminant from the body of water;
the vessel being operable between a first configuration in which said at least one filtration cartridge is supported on the vessel for floating transport across the body of water and a second configuration in which said at least one cartridge is submerged within the body of water such that the filtration media is in open communication with the body of water.

2. The apparatus according to claim 1 wherein the vessel is arranged to engage a floor of the body of water in the first second configuration.

3. The apparatus according to claim 1 wherein said at least one filtration cartridge comprises a plurality of modules of the filtration media supported within a cartridge frame surrounding the modules so as to allow water to flow through the cartridge frame between the modules, and wherein the cartridge frame includes a pallet base such that the cartridge frame is adapted to be transported by pallet handling equipment.

4. The apparatus according to claim 3 further comprising a lift hook mounted centrally at a top of the cartridge frame such that the cartridge frame is adapted to be suspended by the lift hook from a crane.

5. The apparatus according to claim 1 wherein the filtration media comprises nano iron-hydroxide arranged to absorb water soluble phosphates from the body of water.

6. The apparatus according to claim 1 wherein the vessel is arranged to be fully submerged in the first configuration.

7. The apparatus according to claim 6 wherein the vessel includes at least one variable buoyancy chamber operable to displace the vessel between a floating state in the first configuration and a submerged state in the second configuration.

8. The apparatus according to claim 6 wherein the vessel includes flow openings spanning a majority of two laterally opposing sides of the vessel in the first configuration such that the vessel is arranged to receive water flowing laterally through the vessel in the first configuration.

9. The apparatus according to claim 8 further comprising a door operatively associated with each flow opening, the door being operable between (i) an open position in the first configuration in which the flow opening is substantially unobstructed by the door and (ii) a closed position in which the flow opening is closed by the door.

10. The apparatus according to claim 9 wherein each door is hinged at a bottom side of the door such that the door is pivoted downwardly and laterally outwardly from the closed position to the open position.

11. The apparatus according to claim 10 wherein said at least one variable buoyancy chamber comprises an inflatable pontoon mounted to the vessel below the door such that displacement of the door towards the open position collapses the pontoon against a floor of the body of water.

12. The apparatus according to claim 6 wherein the vessel includes loading doors supported at one end of the vessel through which said at least one filtration cartridge is arranged to be loaded and unloaded using pallet handling equipment.

13. The apparatus according to claim 6 wherein the vessel comprises a modified intermodal container, wherein a floor of the container comprises metal grating allowing flow of water therethrough and a top of the container includes a vent opening therein through which air can escape when submerging the vessel.

14. The apparatus according to claim 1 wherein the vessel comprises (i) a hull arranged for flotation on the body of water, (ii) a well communicating through the hull, and (iii) a lift operable to displace said at least one filtration cartridge through the well and relative to the hull between a working position submerged in the body of water below the hull corresponding to the second configuration, and a transport position in which said at least one cartridge is raised relative to the lower position corresponding to the first configuration.

15. The apparatus according to claim 14 wherein the lift supports a lift frame thereon for movement between the working position and the transport position, and wherein said at least one cartridge comprises a plurality of filtration cartridges supported on the lift frame for displacement together with the lift frame between the working position and the transport position.

16. The apparatus according to claim 15 wherein the vessel includes a deck having an upper supporting surface arranged to support pallet handling equipment thereon, and wherein the lift is operable to displace the lift frame into a loading position above the deck such that the filtration cartridges can be loaded onto and unloaded from the lift frame by the pallet handling equipment on the deck.

17. The apparatus according to claim 14 further comprising an anchor post supported on the vessel for vertical displacement between a raised position above a bottom of the hull for transport and a lowered position extending between the hull and a floor of the body of water to anchor the vessel relative to the floor of the body of water.

18. A method of removing a contaminant from a body of water, the method comprising:
providing at least one filtration cartridge supported on a vessel for flotation on the body of water in which the filtration cartridge comprises filtration media arranged to absorb the contaminant from the body of water;
operating the vessel to submerge said at least one cartridge within the body of water such that the filtration media is in open communication with the body of water;
when the filtration media is saturated with the contaminant, raising said at least one filtration cartridge from the body of water and transporting said at least one filtration cartridge to a loading area;
replacing said at least one filtration cartridge on the vessel having saturated filtration media therein with at least one replacement cartridge from the loading area; and
transporting the vessel across the body of water with said at least one replacement cartridge supported thereon.

19. The method according to claim 18 further comprising submerging said at least one filtration cartridge within the body of water by submerging the vessel until the vessel rests on a floor of the body of water.

20. The method according to claim 18 further comprising submerging said at least one filtration cartridge within the body of water by suspending said at least one filtration below the vessel.
